(19) United States
(12) Patent Application Publication
(10) Pub. No.: US 2025/0138541 A1
(43) Pub. Date: May 1, 2025

(54) SYSTEMS AND METHODS FOR CONTROLLING REFUSE VEHICLES

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Elmira, NY (US); Johnny Bui, Oshkosh, WI (US); Nagabhushana Sharma Gurumurthy, Oshkosh, WI (US)

(73) Assignee: Oshkosh Corporation, Oshkosh, WI (US)

(21) Appl. No.: 18/925,739

(22) Filed: Oct. 24, 2024

Related U.S. Application Data
(60) Provisional application No. 63/593,661, filed on Oct. 27, 2023.

(51) Int. Cl. G05D 1/222; G05D 1/698; G05D 105/00; G05D 109/10; G05D 111/30

(52) U.S. Cl. CPC G05D 1/222; G05D 1/6985; G05D 2105/14; G05D 2109/10; G05D 2111/30

(57) ABSTRACT

A remote control system for operating vehicles includes a first vehicle, a second vehicle including one or more controllable elements, and one or more processing circuits. The one or more processing circuits are configured to acquire, from the first vehicle, input data corresponding to the second vehicle, generate, based on the input data, control signals for the one or more controllable elements of the second vehicle, and provide the control signals to the one or more controllable elements of the second vehicle to operate the one or more controllable elements according to the input data.

### CROSS REFERENCE TO RELATED APPLICATIONS

This application claims the benefit of and priority to U.S. Provisional Patent Application No. 63/593,661, filed Oct. 27, 2023, which is incorporated herein by reference in its entirety.

### BACKGROUND

The present disclosure generally relates to the field of refuse vehicles. More specifically, the present disclosure relates to control systems for refuse vehicles.

### SUMMARY

One embodiment of the present disclosure relates to a remote control system for operating vehicles. The remote control system includes a first vehicle, a second vehicle including one or more controllable elements, and one or more processing circuits. The one or more processing circuits are configured to acquire, from the first vehicle, input data corresponding to the second vehicle, generate, based on the input data, control signals for the one or more controllable elements of the second vehicle, and provide the control signals to the one or more controllable elements of the second vehicle to operate the one or more controllable elements according to the input data.

Another embodiment of the present disclosure relates to a method for remotely operating refuse vehicles. The method includes acquiring, from a first refuse vehicle, input data corresponding to a second refuse vehicle, generating, based on the input data, control signals for one or more controllable elements of the second refuse vehicle, and providing the control signals to the one or more controllable elements of the second refuse vehicle to operate the one or more controllable elements according to the input data.

Yet another embodiment of the present disclosure relates to a leader-follower system for remotely operating vehicles. The leader-follower system includes a leader refuse vehicle comprising a telematics unit, a follower refuse vehicle comprising one or more controllable elements, a user device communicably coupled to the telematics unit, the user device configured to generate input data corresponding to the follower refuse vehicle, and one or more processing circuits. The one or more processing circuits are configured to acquire, from the telematics unit of the leader refuse vehicle, the input data corresponding to the follower refuse vehicle, generate, based on the input data, control signals for the one or more controllable elements of the follower refuse vehicle, and provide the control signals to the one or more controllable elements of the follower refuse vehicle to operate the one or more controllable elements according to the input data.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIGS. 1-3, according to an exemplary embodiment;

FIG. 5 is a diagram illustrating a collection route for autonomous transport and collection by any of the refuse vehicles of FIGS. 1-3, according to an exemplary embodiment;

FIG. 6 is a block diagram of a of a leader-follower coordination system, according to an exemplary embodiment;

FIG. 7 is a front view of a user device, according to an exemplary embodiment;

FIG. 8 is an illustration of a graphical user interface for controlling a refuse vehicle shown on the user device of FIG. 7, according to an exemplary embodiment;

FIG. 9 is a diagram illustrating an example of the leader-follower coordination system of FIG. 6, according to an exemplary embodiment;

FIG. 10 is a diagram illustrating an example of the leader-follower coordination system of FIG. 6, according to an exemplary embodiment;

FIG. 11 is a diagram illustrating an example of the leader-follower coordination system of FIG. 6, according to an exemplary embodiment;

FIG. 12 is a diagram illustrating an example of the leader-follower coordination system of FIG. 6 being used at a transfer station, according to an exemplary embodiment;

FIG. 13 is a flow diagram for a process for coordinating operation of a leader vehicle and a follower vehicle, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, a system for coordinating operations of multiple refuse vehicles includes one of the refuse vehicles designated as a leader vehicle and a remainder of the refuse vehicles designated as follower vehicles. The leader vehicle or an operator of the leader vehicle provide input data that is used to generate control signals for the follower vehicles and the follower vehicles are operated according to the control signals. For example, a GPS system of the leader vehicle may provide location data relating to the leader vehicle. The leader vehicle, the follower vehicles, and/or another computing device (e.g., a remote computing device, a user device, etc.) may obtain the location data and generate control signals for controllable elements of the follower vehicle (e.g., a driveline of the follower vehicle, a steering system of the follower vehicle, etc.). The follower vehicle may then be operated according to the control signals such that the follower vehicle is transported proximate the leader vehicle.

The operator of the leader vehicle may also acquire the input data from a user device (e.g., a cellphone, a tablet, a laptop, etc.) that may be removed from the leader vehicle. For example, the operator may input interface data through a graphical user interface of the user device that corresponds to the operation of the follower vehicle. The leader vehicle, the follower vehicles, the user device, or another computing device (e.g., a remote computing device) may generate control signals corresponding to the interface data and operate the follower vehicle according to the control signals.

### Refuse Vehicle

### Front-Loading Configuration

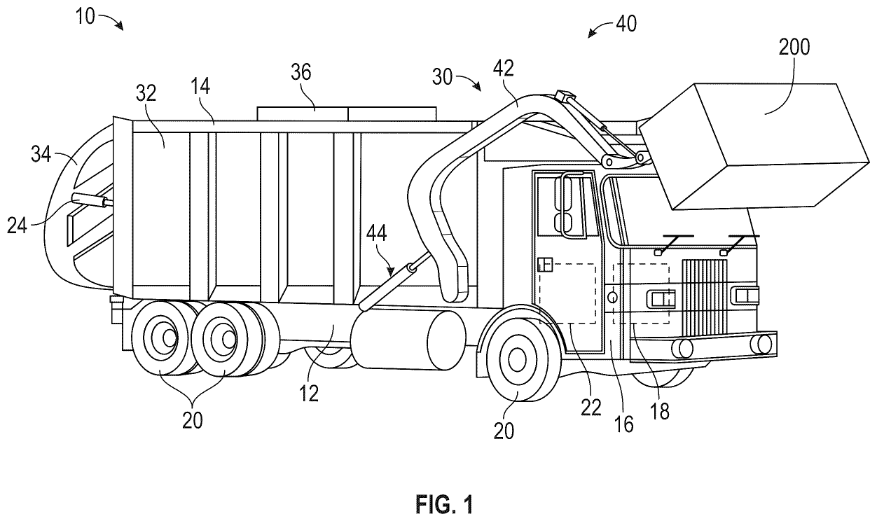

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment 200 as described in greater detail in U.S. application Ser. No. 17/558,183, filed Dec. 12, 2021, the entire disclosure of which is incorporated by reference herein.

### Rear-Loading Configuration

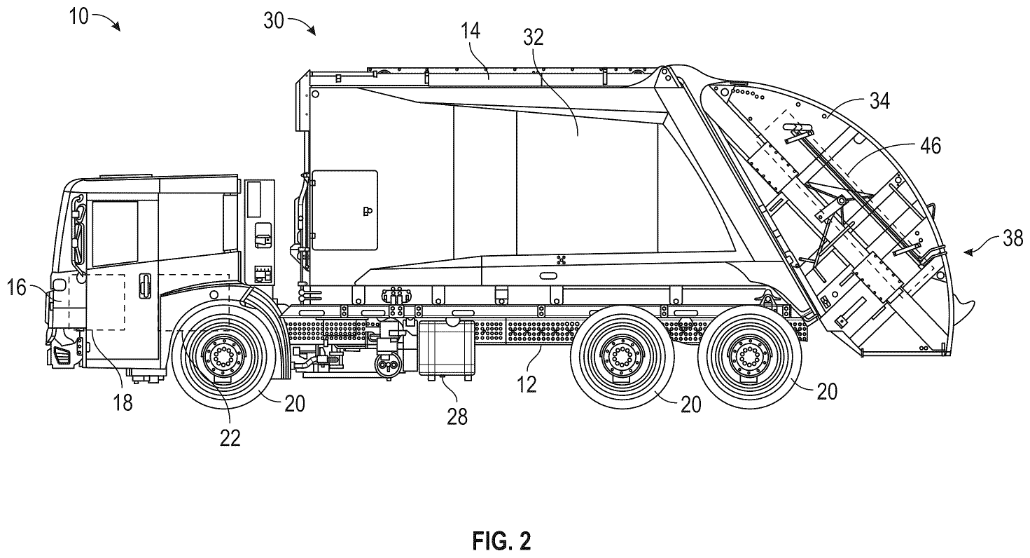

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

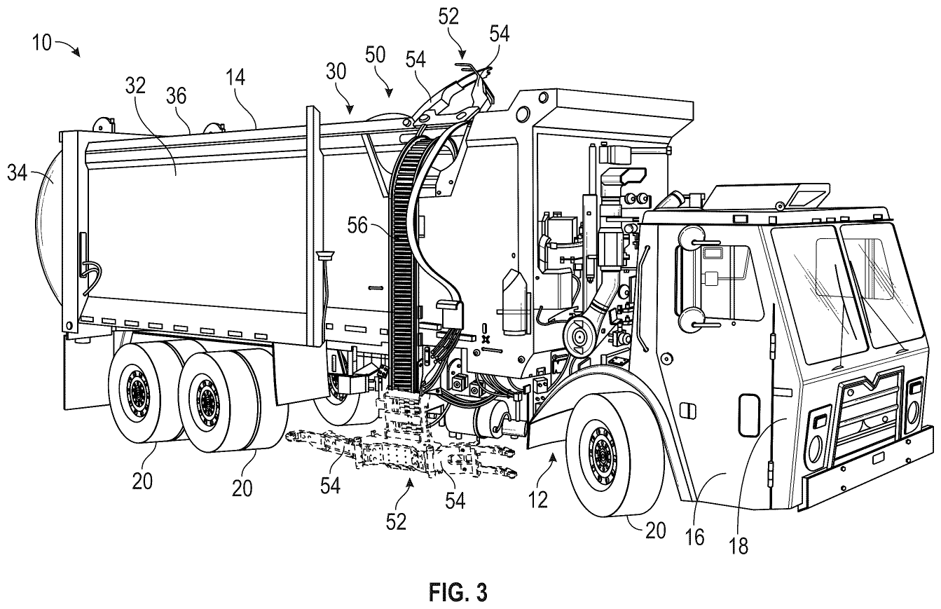

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

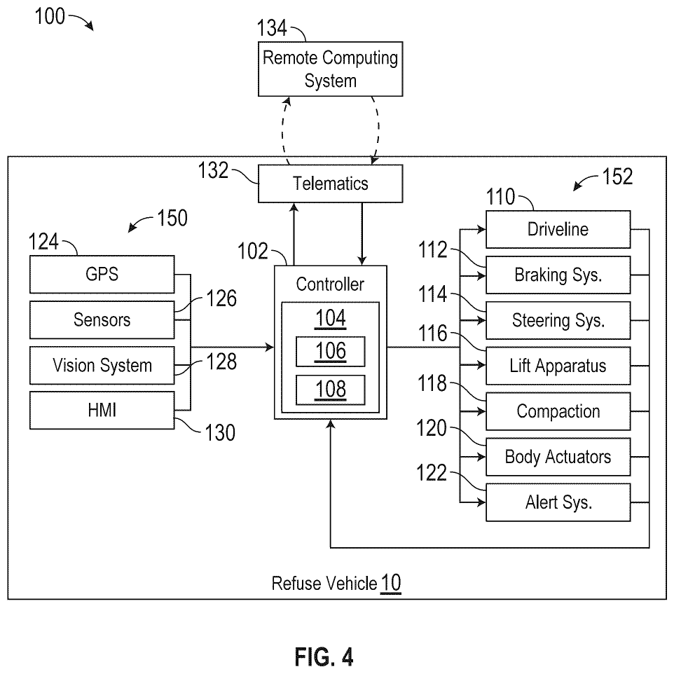

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes one or more processing circuits 104 (e.g., processing circuitry, etc.) including a processor 106 and memory 108. The processing circuits 104 can be communicably connected with a communications interface of controller 102 such that processing circuits 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via the processing circuits 104 and includes computer code for executing (e.g., by at least one of the processing circuits 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI system 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS system 124, the sensors 126, the vision system 128, or the HMI system 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

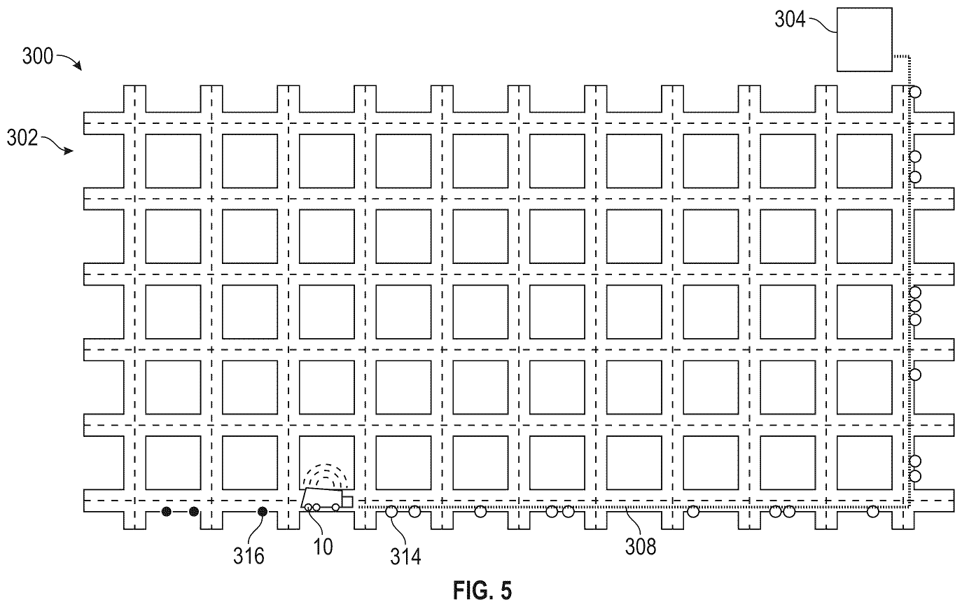

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Leader-Follower Coordination

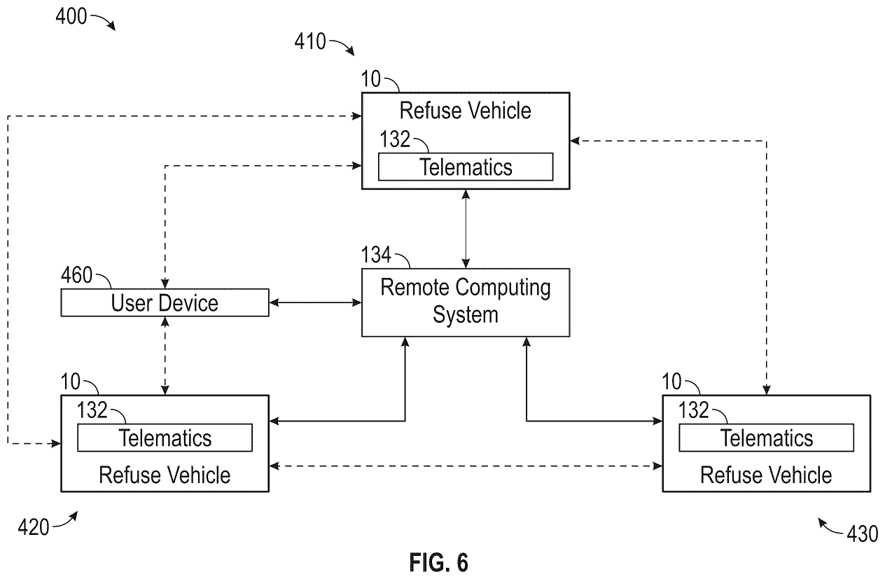

FIG. 6 depicts a block diagram of a leader-follower coordination system or leader-follower telematics system, shown as system 400, according to an exemplary embodiment. The system 400 collects, analyzes, and distributes data pertaining to a plurality of the refuse vehicles 10 to facilitate coordination between the refuse vehicles 10. An operator of a first of the refuse vehicles 10 may use the system 400 to control other of the refuse vehicles 10 along a route to increase operator efficiency by requiring fewer operators to operate the refuse vehicles 10, reduce route completion time, ease a process of unloading the refuse vehicles 10, or otherwise facilitate controlling of the refuse vehicles 10.

As shown in FIG. 6, the system 400 includes the plurality of the refuse vehicles 10, the remote computing system 134, and a user device 460. The system 400 may operate the refuse vehicles 10 such that the refuse vehicles 10 travel together in a caravan (e.g., convoy, column, etc.) while performing operations (e.g., collecting refuse, transporting refuse, transferring refuse at a transfer station, etc.). The telematics units 132 of each of the refuse vehicles 10 may facilitate data communication between the refuse vehicles 10 (e.g., through the mesh network of the refuse vehicles 10, etc.), the remote computing system 134 (e.g., through wireless communication, etc.), or the user device 460. The user device 460 may facilitate communicating information to and from one or more operators. The user device 460 may include any wireless transceiver, cellular dongle, communications radios, antennas, etc., to establish wireless communication with at least one of the refuse vehicles 10 or the remote computing system 134. In some embodiments, the user device 460 may communicate information to the telematics units 132 of each of the refuse vehicles 10.

In some embodiments, system 400 designates one of the refuse vehicles 10 as a leader vehicle 410 and a remainder of the refuse vehicles 10 (e.g., at least one of the other of the refuse vehicles 10, etc.) act as follower vehicles 420. In some embodiments, the follower vehicles 420 are configured to follow a path (e.g., along a route, through a neighborhood, through a transfer station, etc.) taken by the leader vehicle 410, such that the follower vehicles 420 take a path that is substantially similar to the path taken by the leader vehicle 410. For example, if the leader vehicle 410 driven around a block of a neighborhood along a path, the follower vehicles 420 may follow the path around the block of the neighborhood.

In some embodiments, the leader vehicle 410 may also perform some or all of the processing of data (e.g., data acquired from the remote computing system 134, data acquired from the user device 460, etc.) for the follower vehicles 420. By way of example, the leader vehicle 410 may determine a path taken by the leader vehicle 410 and may determine, based on the path, control signals for the follower vehicles 420 that result in the follower vehicles 420 following the path. To facilitate this processing of data, the processing capabilities of the leader vehicle 410 (e.g., of the processing circuits 104 of the leader vehicle 410) may be greater than the processing capabilities of the follower vehicles 420 (e.g., of the processing circuits 104 of the follower vehicles 420). In some embodiments, each of the refuse vehicles 10 are equipped with similar hardware, such that each of the refuse vehicles 10 is capable of acting as the leader vehicle 410. The designation of one of the refuse vehicles 10 as the leader vehicle 410 may be handled by the remote computing system 134, by the user device 460, by an operator of the refuse vehicles 10, by an operator of the leader vehicle 410, or otherwise designated.

In some embodiments, the leader vehicle 410 is another type of vehicle that is not one of the refuse vehicles 10 (e.g., a non-class 8 vehicle, a pickup truck, a sedan, etc.). The leader vehicle 410 may still include the elements and the functionality of the control system 100 as described in detail relative to the refuse vehicle 10 when the leader vehicle 410 is another type of vehicle that is not one of the refuse vehicles 10. For example, the control system 100 of the leader vehicle 410 may still include the input devices 150 to generate inputs and the telematics unit 132 to facilitate communication when the leader vehicle 410 is another type of vehicle that is not one of the refuse vehicles 10.

In some embodiments, the system 400 is configured such that the telematics unit 132 of the leader vehicle 410 facilitates communication between the leader vehicle 410 and the telematics unit 132 of a first of the follower vehicles 420 (e.g., the follower vehicle 420 directly behind the leader vehicle 410, etc.), the telematics unit 132 of the first of the follower vehicles 420 facilitates communication between the first of the follower vehicles 420 and the telematics unit 132 of a second of the follower vehicles 420 (e.g., the third of the refuse vehicles 10, etc.), etc. such that the refuse vehicles 10 form a chain of communication between the leader vehicle 410 and the follower vehicles 420. In some embodiments, the system 400 may be configured such that the telematics unit 132 of the leader vehicle 410 facilitates communication between the leader vehicle 410 and the telematics units 132 of each of the follower vehicles 420. In some embodiments, the system 400 may be configured such that the telematics unit 132 of the leader vehicle 410 facilitates communication between the leader vehicle 410 and the telematics units 132 of each of the follower vehicles 420 through the remote computing system 134. In other embodiments, the system 400 is configured such that the telematics unit 132 of the leader vehicle 410 facilitates communication between the leader vehicle 410 and (i) the telematics unit 132 of a first of the follower vehicles 420 and (ii) the telematics unit 132 of a second of the follower vehicles 420.

In some embodiments, each of the plurality of the refuse vehicles 10 may be configured to collect and store a different type of refuse. For example, the leader vehicle 410 may be configured to collect and store garbage, a first of the follower vehicles 420 may be configured to collect and store recycling, and a second of the follower vehicles 420 may be configured to collect and store organics. By configuring each of the refuse vehicles 10 to collect and store a different type of refuse, the caravan of the refuse vehicles 10 may collect each of the types of refuse along a route without mixing the different types of refuse. Additionally or alternatively, by configuring each of the refuse vehicles 10 to collect and store a different type of refuse, the caravan of refuse vehicles 10 may not need for one of the refuse vehicles 10 to configured to collect and store multiple types of refuse, which may allow for simpler configurations of the refuse vehicles 10. In some embodiments, more than one of the plurality of the refuse vehicles 10 may be configured to collect and store a same type of refuse. For example, the leader vehicle 410 may be configured to collect and store garbage and one of the follower vehicles 420 may be configured to collect and store garbage. By configuring multiple of the refuse vehicles 10 to collect and store the same type of refuse, the caravan of the refuse vehicles 10 may collect and store a greater quantity of the same type of refuse than one of the refuse vehicles 10 could collect and store alone.

In some embodiments, the leader vehicle 410 may be configured substantially differently than the follower vehicles 420, such that the leader vehicle 410 and the follower vehicles 420 are not interchangeable (e.g., the leader vehicle 410 cannot become the follower vehicle 420, the follower vehicles 420 cannot become the leader vehicle 410, etc.). For example, the follower vehicles 420 may be configured as a cabless refuse vehicle that does not include the cab 16 to house an operator. Instead, the follower vehicles 420 may be operated autonomously and/or an operator of the leader vehicle 410 may manually operate the follower vehicle 420 remotely (e.g., from inside of the leader vehicle 410, while walking proximate the follower vehicles 420, while walking ahead of the follower vehicles 420, from inside of a remote control center, etc.). In some embodiments, the follower vehicles 420 may be configured such that the HMI system 130 is positioned on external surfaces of the follower vehicles 420. For example, a control panel for a lift arm of the follower vehicles 420 may be positioned on an outside surface of the refuse compartment 30 such that an operator of the leader vehicle 410 can approach the follower vehicles 420 and operate the control panel without entering the follower vehicles 420. In some embodiments, the operator of the leader vehicle 410 can approach the follower vehicles 420 and manually operate the HMI system 130 of the follower vehicles 420 to complete a difficult operation or maneuver (e.g., an operation or a maneuver that the follower vehicle 420 cannot complete autonomously, etc.).

The system 400 may operate the plurality of the refuse vehicles 10 using input data acquired from the input devices 150 of any of the refuse vehicles 10. In some embodiments, the system 400 may acquire the input data from the input devices 150 of any of the refuse vehicles 10 and provide control outputs to the refuse vehicles 10 to facilitate operation of the refuse vehicles 10. The system 400 may generate the control outputs using the remote computing system 134, the user device 460, any of the controllers 102 of the refuse vehicles 10, etc. In some embodiments, the system 400 may be configured to operate the follower vehicles 420 using leader input data acquired from the input devices 150 of the leader vehicle 410 and/or from interface data acquired from an operator of the leader vehicle 410. The leader input data can include at least one of the GPS location from the GPS system 124 of the leader vehicle 410, sensor data from the sensors 126 of the leader vehicle 410, image data from the vision system 128 of the leader vehicle 410, or user inputs from the HMI system 130 of the leader vehicle 410. In various embodiments, the system 400 may be configured to operate the follower vehicles 420 using the leader input data acquired from a combination of the input devices 150 of the leader vehicle 410.

In some embodiments, the system 400 may operate the refuse vehicles 10 using GPS data from the GPS system 124 of any of the refuse vehicles 10. The system 400 may acquire GPS data from the GPS system 124 of the leader vehicle 410 and operate the follower vehicles 420 based on the GPS data. For example, an operator of the leader vehicle 410 may operate the leader vehicle 410 along a path. The system 400 may be configured to acquire the leader input data including the GPS location of the leader vehicle 410 from the GPS system 124 of the leader vehicle 410. The system 400 may determine control signals for the controllable elements 152 of the follower vehicles 420 to transport the follower vehicles 420 to a position proximate the leader vehicle 410 and provide the controllable elements 152 of the follower vehicles 420 with the control signals such that the follower vehicles 420 are transported to the position proximate the leader vehicle 410. For another example, an operator of the leader vehicle 410 may operate the leader vehicle 410 along a path. The system 400 may be configured to acquire the leader input data including GPS locations of the leader vehicle 410 as the leader vehicle 410 traveled along the path. The system 400 may determine control signals for the controllable elements 152 of the follower vehicles 420 that cause the follower vehicles 420 to follow the path based on the leader input data.

In some embodiments, the system 400 may operate the refuse vehicles 10 using sensor data from the sensors 126 of each of the refuse vehicles 10. The system 400 may acquire sensor data from the sensors 126 of the leader vehicle 410 and operate the follower vehicles 420 based on the sensor data from the sensors 126 of the leader vehicle 410. For example, an operator of the leader vehicle 410 may operate the leader vehicle 410 along a path. The system 400 may be configured to acquire the leader input data including sensor data relating to a distance traveled by the leader vehicle 410 (e.g., through an odometer counting a number of revolutions of the wheels 20, etc.). The system 400 may determine control signals for the controllable elements 152 of the follower vehicles 420 based on the leader input data to transport the follower vehicles 420 to a position proximate the leader vehicle 410 and/or transport the follower vehicles 420 along the path and provide controllable elements 152 of the follower vehicles 420 with the control signals such that the follower vehicles 420 are transported to the position proximate the leader vehicle 410 and/or are transported along the path.

In some embodiments, the system 400 may operate the refuse vehicles 10 using image data from the vision system 128 of each of the refuse vehicles 10. The system 400 may acquire image data from the vision system 128 of the leader vehicle 410 and operate the follower vehicles 420 based on the image data from the vision system 128 of the leader vehicle 410. For example, the leader vehicle 410 may be positioned such that a field of view of the vision system 128 of the leader vehicle 410 includes an area behind the leader vehicle 410 that includes an obstacle. The system 400 may be configured to acquire the leader input data including image data relating to the obstacle behind the leader vehicle 410. The system 400 may determine control signals for the controllable elements 152 of the follower vehicles 420 based on the leader input to transport the follower vehicles 420 to a position proximate the leader vehicle 410 while avoiding the obstacle behind the leader vehicle 410. The system 400 may provide the controllable elements 152 of the follower vehicles 420 with the control signals such that the follower vehicles 420 are transported to the position proximate the leader vehicle 410 while avoiding (e.g., without contacting, etc.) the obstacle behind the leader vehicle 410.

In some embodiments, system 400 may acquire image data from the vision system 128 of the follower vehicles 420 and operate the follower vehicles 420 based on the image data from the vision system 128 of the follower vehicles 420. For example, the leader vehicle 410 may be positioned forward of the follower vehicles 420 and a field of view of the vision system 128 of the follower vehicles 420 may include the leader vehicle 410. The system 400 may be configured to acquire the image data from the vision system 128 of the follower vehicles 420. The system 400 may determine control signals for the controllable elements 152 of the follower vehicles 420 based on the image data to transport the follower vehicles 420 to a position proximate the leader vehicle 410 and provide the controllable elements 152 with the control signals such that the follower vehicles 420 are transported to the position proximate the leader vehicle 410.

In some embodiments, the system 400 may operate the plurality of the refuse vehicles 10 using interface data from the HMI system 130 of each of the refuse vehicles 10. The system 400 may acquire interface data from the HMI system 130 of the leader vehicle 410 and operate the follower vehicles 420 based on the interface data from the HMI system 130 of the leader vehicle 410. For example, the follower vehicle 420 may be positioned proximate a refuse container. An operator of the leader vehicle 410 may input a user input to the HMI system 130 of the leader vehicle 410 corresponding to the follower vehicle 420 collecting refuse from the refuse container. The system 400 may be configured to acquire the interface data from the HMI system 130 of the leader vehicle 410. The system 400 may determine control signals for the controllable elements 152 of the follower vehicle 420 based on the interface data to collect refuse from the refuse container (e.g., grasp the refuse container and perform a dump cycle with the lift assembly 50, etc.) and provide the controllable elements 152 of the follower vehicle 420 with the control signal such that the follower vehicle 420 collects the refuse from the refuse container.

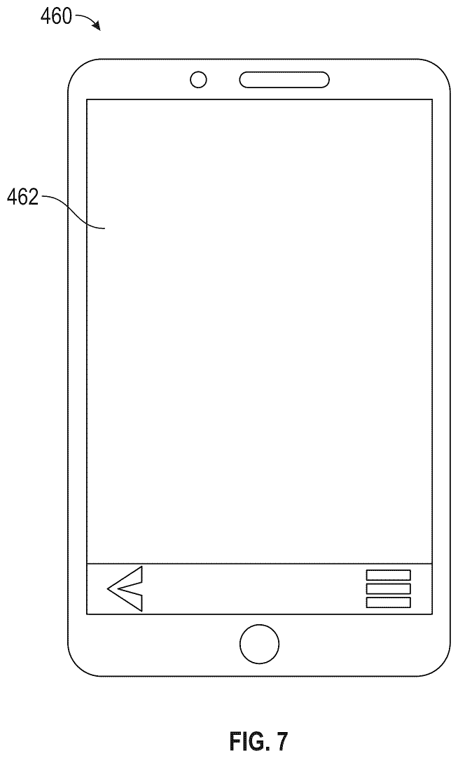

Referring to FIG. 7, the user device 460 may be configured to facilitate providing various features such as navigation (e.g., a global positioning system (“GPS”), etc.), troubleshooting walk-throughs, schematics, manuals, three-dimensional (“3D”) models, automatic feature/option camera detection, calibration, settings, diagnostics, augmented reality (“AR”), and/or remote operation, among other possible features.

In some embodiments, the user device 460 is a portable electronic device (e.g., such as a table, laptop, smartphone, etc.) such that the user device 460 may be removed from one of the refuse vehicles 10 (e.g., an interior of the cab 16, another portion of the vehicle 10 where the user device 460 may otherwise be detachably coupled). The user device 460 has an interface, shown as display screen 462. The display screen 462 may be configured to provide a graphical user interface (“GUI”) to an operator thereof and facilitate receiving touch inputs or commands. The user device 460 may employ any suitable wireless communication protocol (e.g., Wi-Fi, cellular, radio, Bluetooth, near-field communication, etc.) to facilitate wireless communication between the user device 460 and the telematics units 132 of the refuse vehicles 10 and/or the remote computing system 134. In some embodiments, the user device 460 is capable of being selectively directly coupled to the controllers 102 of the refuse vehicles 10 with a wired connection inside of the cabs 16 of the refuse vehicles 10.

According to an exemplary embodiment, the user device 460 is configured to facilitate an operator in providing commands to the controllable elements 152 (e.g., the driveline 110, the braking system 112, the steering system 114, the lift apparatus 116, etc.) and/or input devices 150 of the refuse vehicles 10. Such commands may be provided while an operator is within the cab 16 of the refuse vehicles 10 and/or external from the cab 16 of the refuse vehicles 10. By way of example, the operator of the refuse vehicles 10 may be able to actuate the lift arm actuators 44 to raise and lower the lift assembly 40 with the user device 460. By way of another example, the operator of the refuse vehicles 10 may be able to actuate the tailgate actuators 43 to raise and lower the tailgate 34 with the user device 460. By way of still another example, the operator of the refuse vehicles 10 may be able to control driving and steering the refuse vehicle 10 remotely with the user device 460. In some embodiments, the remote computing system 134 is configured to facilitate providing commands to the controllable elements 152 and/or the input devices 150 of the refuse vehicles 10 from a remote location (e.g., directly, indirectly through the user device 460, etc.). In some embodiments, the operator may provide commands to the controllable elements 152 of the refuse vehicles 10 during difficult operations or maneuvers. For example, the follower vehicle 420 may typically autonomously follow the leader vehicle 410 based on input data from the leader vehicle 410. However, during a sharp turn the operator of the leader vehicle 410 may provide commands to the controllable elements 152 of the follower vehicle 420 such that the follower vehicle 420 is manually controlled through the sharp turn. The follower vehicle 420 may resume autonomous operation after completing the sharp turn to continue following the leader vehicle 410.

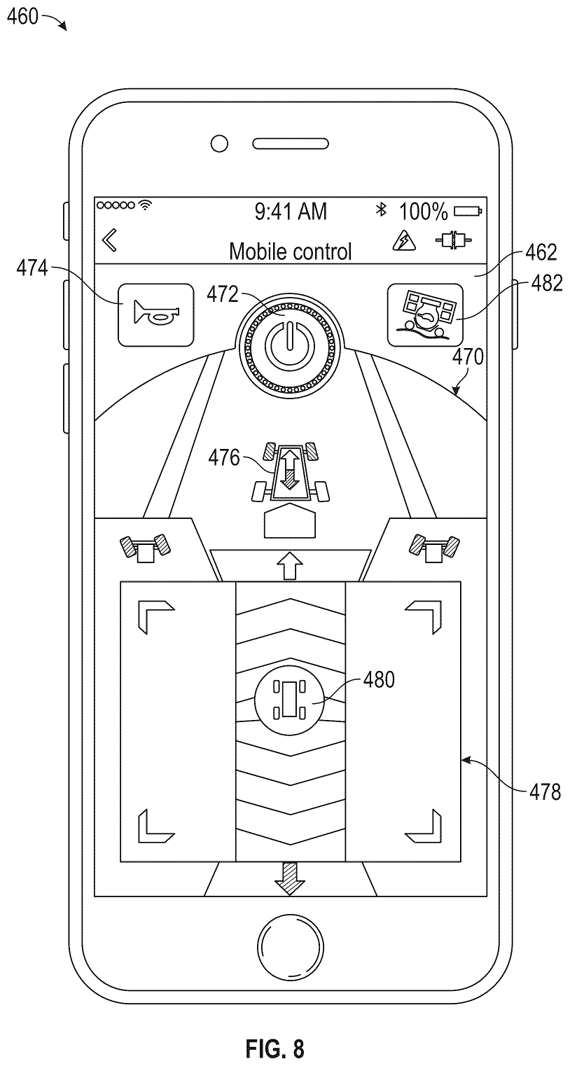

According to the exemplary embodiments shown in FIGS. 8, the user device 460 is configured to provide a Graphical User Interface (GUI) on the display screen 462 to facilitate connecting to and controlling operation of the refuse vehicles 10 with the user device 460. As shown in FIG. 8, a GUI, shown as remote-control GUI 470, is presented to the user via the display screen 462. The remote-control GUI 470 is configured to facilitate remotely controlling the controllable elements 152 of the refuse vehicles 10 with the user device 460. By way of example, the remote-control GUI 470 may facilitate controlling the driveline 110, the braking system 112, the steering system 114, the lift apparatus 116, among still other controllable components of the refuse vehicles 10.

As shown in FIG. 8, the remote-control GUI 470 includes a first button, shown as power button 472, a second button, shown as horn button 474, a third button, shown as speed toggle button 476, an interface, shown as drive and steer operation trackpad 478, and a fourth button, shown as auxiliary button 482. The power button 472 is configured to facilitate turning on and off the prime mover (e.g., the engine 18, etc.) of the refuse vehicle 10. The horn button 474 is configured to facilitate activating and sounding a horn of the refuse vehicle 10. The speed toggle button 476 is configured to facilitate toggling between speed modes of the refuse vehicle 10. By way of example, the speed modes may include a low torque and high speed mode (rabbit mode), a high torque and low speed mode (turtle mode), and/or one or more intermediate modes. As shown in FIG. 8, the drive and steer operation trackpad 478 includes a repositionable button, shown as drive button 480, that is selectively repositionable within the drive and steer operation trackpad 780. According to an exemplary embodiment, repositioning the drive button 480 facilitates driving and turning the vehicle 10 remotely with the user device 460. In some embodiments, the user device 460 is configured to provide haptic feedback to the user of the user device 460 when the drive button 480 interacts with a border of the drive and steer operation trackpad 478 (e.g., indicating a speed extreme, a turning extreme, etc.). The auxiliary button 482 is configured to facilitate operating the controllable elements 152 of the refuse vehicles 10. For example, when a user selects the auxiliary button 482, the lift apparatus 116 of the refuse vehicle 10 may perform an automated handling and dump cycle with a refuse container. The user device 460 may also operate similar to the user I/O device 200 as described in greater detail in U.S. application Ser. No. 17/141,348, filed Jan. 5, 2021, the entire disclosure of which is incorporated by reference herein.

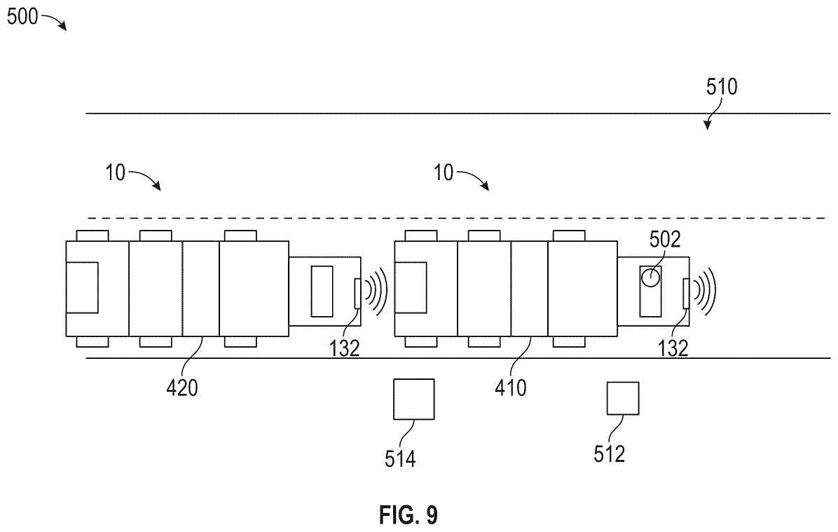

Referring to FIG. 9, a diagram 500 illustrates an example of the system 400 coordinating the operation of a plurality of the refuse vehicles 10 is shown, according to some embodiments. The diagram 500 illustrates a first of the refuse vehicles 10 as the leader vehicle 410 and a second of the refuse vehicles 10 as the follower vehicle 420. The telematics unit 132 of the leader vehicle 410 facilitates communication between the leader vehicle 410 and the telematics unit 132 of the follower vehicle 420. The diagram 500 illustrates an operator 502 (e.g., an operator of the leader vehicle 410) positioned in the cab 16 of the leader vehicle 410 operating the leader vehicle 410 and the follower vehicle 420. The diagram 500 illustrates the plurality of the refuse vehicles 10 on a roadway 510. Proximate the roadway 510 is a first refuse container 512 and a second refuse container 514. The system 400 may be used by the operator 502 to operate the leader vehicle 410 and the follower vehicle 420 to collect and store refuse contained in the first refuse container 512 and the second refuse container 514. For example, the operator 502 may operate the leader vehicle 410 to collect and store the refuse contained in the first refuse container 512 through the HMI system 130 of the leader vehicle 410. The operator 502 may operate the leader vehicle 410 and the follower vehicle 420 to transport the leader vehicle 410 and the follower vehicle 420 along the roadway 510 such that the follower vehicle 420 is in a position to collect and store the refuse contained in the second refuse container 514 and operate the follower vehicle 420 to collect and store the refuse contained in the second refuse container 514.

Still referring to FIG. 9, in some embodiments, the operator 502 may operate the leader vehicle 410 through the HMI system 130 of the leader vehicle 410 to transport the leader vehicle 410 along the roadway 510 and the follower vehicle 420 may autonomously follow the leader vehicle 410 along the roadway 510 (e.g., based on data from the input devices 150 of the leader vehicle 410, based on the data from the input devices 150 of the follower vehicle 420, based on a combination of the data from the input devices 150 of the leader vehicle 410 and the data from the input devices 150 of the follower vehicle 420, etc.). In some embodiments, the operator 502 may operate the leader vehicle 410 and the follower vehicle 420 through the HMI system 130 of the leader vehicle 410 to transport the leader vehicle 410 and the follower vehicle 420 along the roadway 510. In some embodiments, the operator 502 may operate the follower vehicle 420 to collect and store the refuse contained in the second refuse container 514 through the HMI system 130 of the leader vehicle 410. In some embodiments, the follower vehicle 420 may autonomously collect and store the refuse contained in the second refuse container 514 based on data from the input devices 150 of the follower vehicle 420.

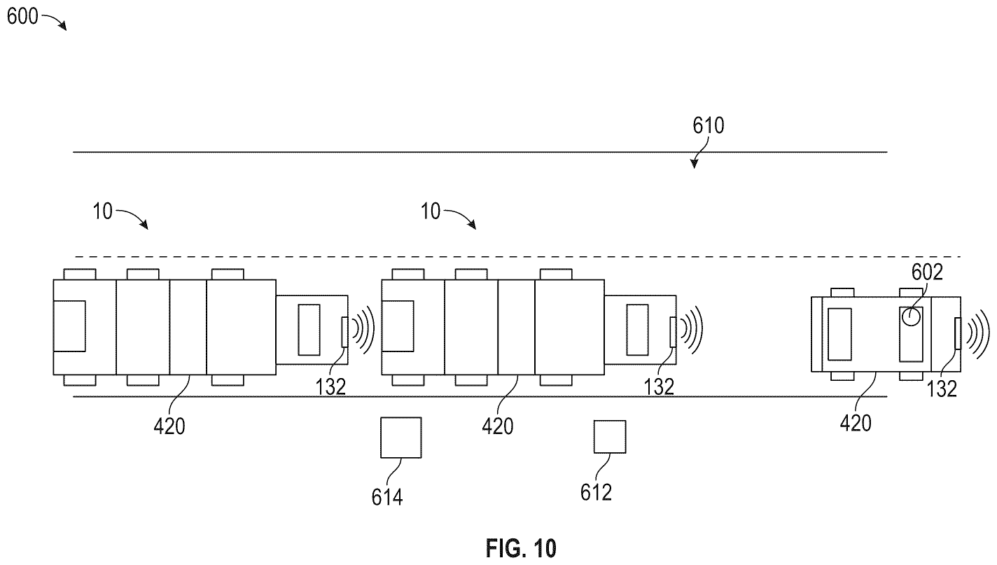

Referring to FIG. 10, a diagram 600 illustrates an example of the system 400 coordinating the operation of a plurality of the refuse vehicles 10 is shown, according to some embodiments. The diagram 600 illustrates a vehicle other than (e.g., a non-class 8 vehicle, a pickup truck, a sedan, etc.) the refuse vehicles 10 as the leader vehicle 410, a first of the refuse vehicles 10 as a first of the follower vehicles 420, and a second of the refuse vehicles 10 as a second of the follower vehicles 420. The telematics unit 132 of the leader vehicle 410 facilitates communication between the leader vehicle 410 and the telematics units 132 of the follower vehicles 420. The diagram 600 illustrates an operator 602 positioned in the leader vehicle 410 (e.g., an operator of the leader vehicle 410) operating both of the follower vehicles 420. The diagram 600 illustrates the leader vehicle 410 and the plurality of the refuse vehicles 10 on a roadway 610. Proximate the roadway 610 is a first refuse container 612 and a second refuse container 614. The system 400 may be used by the operator 602 to operate the follower vehicles 420 to collect and store refuse contained in the first refuse container 612 and the second refuse container 614. For example, the operator 602 may operate the first of the follower vehicles 420 to collect and store the refuse contained in the first refuse container 612 through the HMI system 130 of the leader vehicle 410. The operator 602 may operate the follower vehicles 420 to transport the follower vehicles 420 along the roadway 610 such that the second of the follower vehicles 420 is in a position to collect and store the refuse contained in the second refuse container 614 and operate the second of the follower vehicles 420 to collect and store the refuse contained in the second refuse container 614.

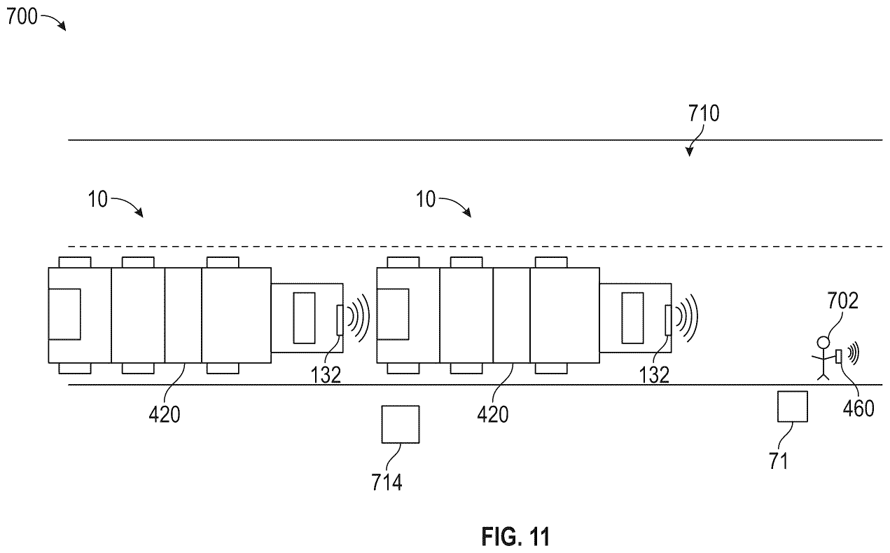

Referring to FIG. 11, a diagram 700 illustrates an example of the system 400 coordinating the operation of a plurality of the refuse vehicles 10 is shown, according to some embodiments. The diagram 700 illustrates a first of the refuse vehicles 10 as the leader vehicle 410 and a second of the refuse vehicles 10 as the follower vehicle 420. The telematics unit 132 of the leader vehicle 410 facilitates communication between the leader vehicle 410 and the telematics unit 132 of the follower vehicle 420. The diagram 700 illustrates an operator 702 positioned outside of the cab 16 of the leader vehicle 410 (e.g., an operator of the leader vehicle 410) holding the user device 460. The user device 460 may be associated with the leader vehicle 410 and may facilitate communication between the operator 702, the telematics unit 132 of the leader vehicle 410, and the telematics units 132 of the follower vehicle 420. The operator 702 may be positioned outside of the leader vehicle 410 to facilitate the operation of the refuse vehicles 10. For example, the operator 702 may stage (e.g., position, orientate, etc.) refuse containers to facilitate the operation of the refuse vehicles 10 collecting and storing refuse contained in the refuse containers. In some embodiments, the operator 702 may use an intermediate vehicle (e.g., a handler vehicle, a cart handler robot, etc.) to stage the refuse containers. The diagram 700 illustrates the leader vehicle 410, the follower vehicle 420, and the operator 702 positioned on a roadway 710. Proximate the roadway 710 is a first refuse container 712 and a second refuse container 714. The system 400 may be used by the operator 702 to operate the leader vehicle 410 to collect and store refuse contained in the first refuse container 712 and operate the follower vehicle 420 to collect and store refuse contained in the second refuse container 714 through the user device 460. For example, the operator 702 may operate the leader vehicle 410 to collect and store the refuse contained in the first refuse container 712 through the user device 460. The operator may operate the leader vehicle 410 and the follower vehicle 420 to transport the leader vehicle 410 and the follower vehicle 420 along the roadway 710 using the user device 460 such that the follower vehicle 420 is in a position to collect and store the refuse contained in the second refuse container 714. The operator 702 may operate the second of the follower vehicles 420 to collect and store the refuse contained in the second refuse container 714 through the user device 460.

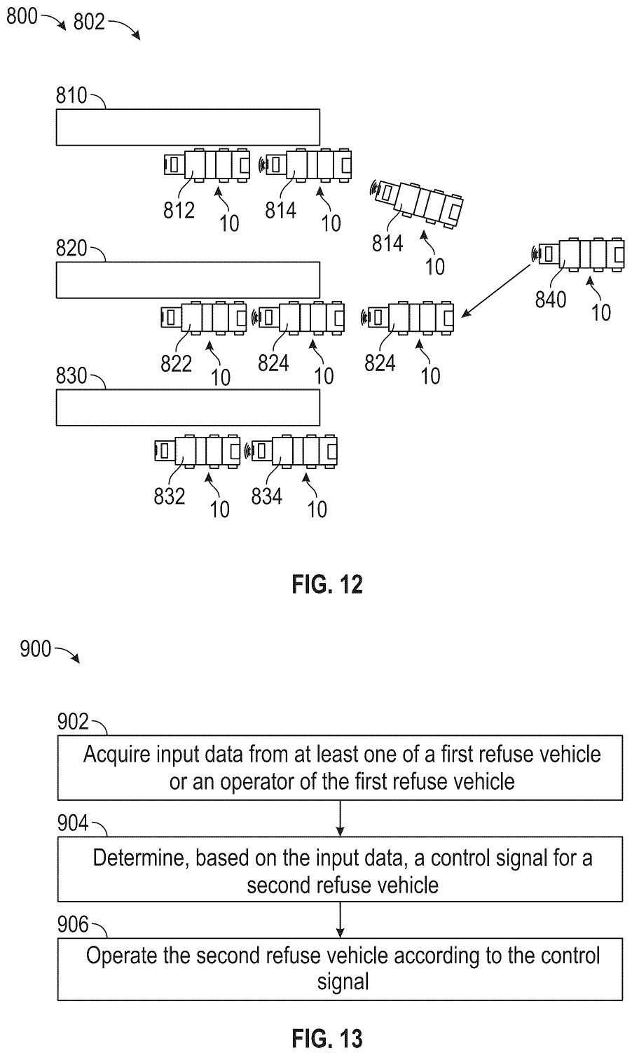

Referring to FIG. 12, a diagram 800 illustrates an example of the system 400 coordinating the operation of a plurality of the refuse vehicles 10 is shown, according to some embodiments. The diagram 800 illustrates a transfer station 802. The transfer station 802 is a location in which the refuse vehicles 10 transfer a payload. For example, the refuse vehicles 10 may transfer a payload of refuse at the transfer station 802. The refuse vehicles 10 may transport the payload to the transfer station 802 to dump the payload a dump zone. The dump zone may be part of a landfill, another vehicle, or a location from which the refuse will be loaded into another vehicle. The diagram 800 illustrates a first dump zone, shown as garbage dump zone 810, a second dump zone, shown as recycling dump zone 820, and a third dump zone, shown as organics dump zone 830. The garbage dump zone 810 may be configured to receive payloads from the refuse vehicles 10 containing garbage, the recycling dump zone 820 may be configured to receive payloads from the refuse vehicles 10 containing recycling, and the organics dump zone 830 may be configured to receive payloads from the refuse vehicles 10 containing organics.

Still referring to FIG. 12, the diagram 800 illustrates a first of the refuse vehicles 10 proximate the garbage dump zone 810 as a garbage leader vehicle 812 (e.g., the leader vehicle 410), a first plurality of the refuse vehicles 10 proximate the garbage dump zone 810 as garbage follower vehicles 814 (e.g., the follower vehicles 420), a second of the refuse vehicles 10 proximate the recycling dump zone 820 as a recycling leader vehicle 822 (e.g., the leader vehicle 410), a second plurality of the refuse vehicles 10 proximate the recycling dump zone 820 as recycling follower vehicles 824 (e.g., the follower vehicles 420), a third of the refuse vehicles 10 proximate the organics dump zone 830 as an organics leader vehicle 832 (e.g., the leader vehicle 410), and a third plurality of the refuse vehicles 10 proximate the organics dump zone 830 as organics follower vehicles 834 (e.g., the follower vehicles 420). The garbage leader vehicle 812 and the garbage follower vehicles 814 contain payloads of garbage. The garbage follower vehicles 814 are configured to follow the garbage leader vehicle 812 through the transfer station 802 to deposit the payloads of garbage to the garbage dump zone 810. In some embodiments, the garbage follower vehicles 814 are configured to follow the garbage leader vehicle 812 through the transfer station 802 autonomously or under the operation of an operator of the garbage leader vehicle 812. For example, the garbage follower vehicles 814 may autonomously follow the garbage leader vehicle 812 through the transfer station 802 until each of the garbage follower vehicles 814 reaches a position proximate the garbage dump zone 810. When each of the garbage follower vehicles 814 reaches the position, an operator of the garbage leader vehicle 812 may remotely control (e.g., from the cab 16 of the garbage leader vehicle 812, external to the cab 16 of the garbage leader vehicle 812 via the user device 460, etc.) each of the garbage follower vehicles 814 to dump garbage into the garbage dump zone 810.

Still referring to FIG. 12, the diagram 800 additionally illustrates the recycling follower vehicles 824 following the recycling leader vehicle 822 through the transfer station 802 to deposit payloads of recycling to the recycling dump zone 820 and the organics follower vehicles 834 following the organics leader vehicle 832 through the transfer station 802 to deposit payloads of organics to the organics dump zone 830. In some embodiments, the system 400 is configured to assign one of the refuse vehicles 10 approaching the transfer station 802 as one of the follower vehicles 420 and assign the follower vehicle to one of the leader vehicle 410 based on a type of refuse contained in the follower vehicle 420 (e.g., a parameter associated with the follower vehicle 420, etc.). As illustrated in the diagram 800, the refuse vehicle 10 approaching the site is shown as new refuse vehicle 840 and the type of refuse contained in the new refuse vehicle 840 is recycling. The system 400 may assign the new refuse vehicle 840 as one of the recycling follower vehicles 824 and operate the new refuse vehicle 840 into a position to follow the recycling leader vehicle 822 through the transfer station 802 to deposit the recycling to the recycling dump zone 820.

### Process for Leader-Follower Coordination

Referring to FIG. 13, a flow diagram of a process 900 for coordinating operation of a leader vehicle and a follower vehicle includes steps 902-906, according to some embodiments. In some embodiments, the process 900 is performed by the controller 102 based on data obtained from one or more of the input devices 150 of at least one of the refuse vehicles 10. The process 900 may be implemented in order to operate the follower vehicle 420 based on input data acquired from the leader vehicle 410.

The process 900 includes acquiring (e.g., obtaining, etc.) input data from at least one of a first refuse vehicle or an operator of the first refuse vehicle (step 902), according to some embodiments. Step 902 can be performed by the controller 102 of a first of the refuse vehicles 10, the remote computing system 134, the controller 102 of a second of the refuse vehicles 10, or the user device 460 by obtaining input data from the input devices 150 of the first of the refuse vehicles 10. In some embodiments, step 902 may be performed by the controller 102 of the leader vehicle 410. For example, the leader vehicle 410 may receive interface data inputted by an operator of the leader vehicle 410 through the HMI system 130, location data from the GPS system 124, image data from the vision system 128, etc. In some embodiments, the leader vehicle 410 may receive the interface data inputted by an operator through the user device 460. In some embodiments, the input data may be obtained directly from a user device 460. For example, the input data may be inputted by an operator through the user device 460 and not provided to the first refuse vehicle (e.g., the leader vehicle 410, etc.). In some embodiments, the input data from the operator of the first refuse vehicle 10 may be obtained from the HMI system 130 of the second of the refuse vehicles 10 (e.g., the follower vehicle 420). For example, the operator of the first of the refuse vehicles 10 (e.g., the leader vehicle 410) may provide inputs to the HMI system 130 that is external the second of the refuse vehicles 10 before returning to the first of the refuse vehicles 10.

The process 900 includes determining a control signal for a second refuse vehicles (step 904), according to some embodiments. In some embodiments, the control signal for the second refuse vehicle may be determined based on the input data obtained during step 902. Step 902 can be performed by the controller 102 of a first of the refuse vehicles 10, the remote computing system 134, the controller 102 of a second of the refuse vehicles 10, or the user device 460. In some embodiments, step 904 is performed by the leader vehicle 410 or by the follower vehicle 420. For example, the input data obtained during step 902 may include a position of the first of the refuse vehicles 10 (e.g., the leader vehicle 410). The remote computing system 134 may obtain the input data including the position of the first of the refuse vehicles 10 and generate control signals for the controllable elements 152 of the second of the refuse vehicles 10 (e.g., the follower vehicle (e.g., the follower vehicle 420) to operate the second of the refuse vehicles 10 to a position proximate the first of the refuse vehicles 10. As another example, the controller 102 may obtain the input data including interface data inputted by the operator of the first refuse vehicle 10 into the user device 460 corresponding to the operation of the second of the refuse vehicles 10. The controller 102 of the second of the refuse vehicles 10 may generate control signals for the controllable elements 152 of the second of the refuse vehicles 10 to operate the second of the refuse vehicles 10 according to the interface data inputted by the operator of the first refuse vehicle 10.

The process 900 includes operating the second refuse vehicle according to the control signal (step 906), according to some embodiments. Step 906 can be performed by the controller 102 of the second of the refuse vehicles 10. In some embodiments, step 906 may be performed by the controller 102 of the follower vehicle 420. For example, if the control signal of step 904 were determined by the controller 102 of the follower vehicle 420, the controller 102 of the follower vehicle 420 may operate the follower vehicle 420 according to the control signal. As another example, if the control signal of step 904 were determined by the remote computing system 134, then the controller 102 of the second of the refuse vehicles 10 may receive the control signal from the remote computing system 134 through the telematics unit 132 of the second of the refuse vehicles. The controller 102 of the second of the refuse vehicles 10 may operate the second of the refuse vehicles 10 according to the control signal. For example, the control signal may correspond with operating the driveline 110 of the second of the refuse vehicles 10 to transport the second of the refuse vehicles 10 to a position proximate the first of the refuse vehicles 10, the control signal may correspond with operating the steering system 114 of the second of the refuse vehicles 10 to follow a path of the first of the refuse vehicles 10, the control signal may correspond with operating the lift apparatus 116 of the second of the refuse vehicles 10 to handle a refuse container, etc.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A remote control system for remotely operating vehicles, the remote control system comprising:
a first vehicle;
a second vehicle comprising one or more controllable elements; and
one or more processing circuits configured to:
acquire, from the first vehicle, input data corresponding to the second vehicle;
generate, based on the input data, control signals for the one or more controllable elements of the second vehicle; and
provide the control signals to the one or more controllable elements of the second vehicle to operate the one or more controllable elements according to the input data.

2. The remote control system of claim 1, wherein:
the first vehicle is a first refuse vehicle comprising:
a first chassis; and
a first body coupled to the first chassis, the first body defining a first refuse compartment configured to store refuse therein; and
the second vehicle is a second refuse vehicle comprising:
a second chassis; and
a second body coupled to the second chassis, the second body defining a second refuse compartment configured to store refuse therein.

3. The remote control system of claim 2, wherein the first vehicle further comprises an input device configured to generate the input data based on a user input from an operator of the first vehicle.

4. The remote control system of claim 3, wherein:
the first vehicle further comprises a cab coupled to the first chassis, the input device positioned within the cab; and
the second vehicle is a cabless refuse vehicle.

5. The remote control system of claim 2, wherein the first refuse compartment is configured to store a first type of refuse and the second refuse compartment is configured to store a second type of refuse different from the first type of refuse.

6. The remote control system of claim 2, wherein the one or more processing circuits are configured to assign the second vehicle to the first vehicle based the second vehicle being configured to collect and store a type of refuse.

7. The remote control system of claim 1, wherein the first vehicle comprises:
the one or more processing circuits; and
a telematics unit configured to provide the control signals to the one or more controllable elements of the second vehicle.

8. The remote control system of claim 1, further comprising a portable user device associated with the first vehicle, the portable user device configured to:
generate the input data based on a user input; and
provide the input data to the first vehicle.

9. The remote control system of claim 8, wherein the portable user device is configured to wirelessly connect to the first vehicle to provide the input data to the first vehicle.

10. The remote control system of claim 1, wherein:
the input data corresponds to a location of the first vehicle; and
the one or more processing circuits are configured to generate the control signals to cause the one or more controllable elements of the second vehicle to transport the second vehicle to a position proximate the location of the first vehicle.

11. The remote control system of claim 1, wherein:
the input data corresponds to a path taken by the first vehicle; and
the one or more processing circuits are configured to generate the control signals to cause the one or more controllable elements of the second vehicle to transport the second vehicle along the path.

12. A method for remotely operating refuse vehicles, the method comprising:
acquiring, from a first refuse vehicle, input data corresponding to a second refuse vehicle;
generating, based on the input data, control signals for one or more controllable elements of the second refuse vehicle; and
providing the control signals to the one or more controllable elements of the second refuse vehicle to operate the one or more controllable elements according to the input data.

13. The method of claim 12, further comprising:
acquiring from, the second refuse vehicle, a parameter corresponding to the second refuse vehicle;
determining, based on the parameter, to assign the second refuse vehicle to a third refuse vehicle;
acquiring, from the third refuse vehicle, updated input data corresponding to the second refuse vehicle;
generating, based on the updated input data, updated control signals for the one or more controllable elements of the second refuse vehicle; and
providing the updated control signals to the one or more controllable elements of the second refuse vehicle to operate the one or more controllable elements of the second refuse vehicle according to the updated input data.

14. The method of claim 13, wherein the parameter is a type of refuse associated with the second refuse vehicle.

15. The method of claim 12, wherein:
the input data corresponds to a location of the first refuse vehicle; and
the control signals cause the one or more controllable elements of the second refuse vehicle to transport the second refuse vehicle towards the first refuse vehicle.

16. The method of claim 12, wherein:
the input data corresponds to a refuse container; and
the control signals cause the one or more controllable elements of the second refuse vehicle to engage the refuse container and transfer refuse from the refuse container into a refuse compartment of the second refuse vehicle.

17. A leader-follower system for remotely operating vehicles, the leader-follower system comprising:
a leader refuse vehicle comprising a telematics unit;
a follower refuse vehicle comprising one or more controllable elements;
a user device communicably coupled to the telematics unit, the user device configured to generate input data corresponding to the follower refuse vehicle; and
one or more processing circuits configured to:
acquire, from the telematics unit of the leader refuse vehicle, the input data corresponding to the follower refuse vehicle;
generate, based on the input data, control signals for the one or more controllable elements of the follower refuse vehicle; and
provide the control signals to the one or more controllable elements of the follower refuse vehicle to operate the one or more controllable elements according to the input data.

18. The leader-follower system of claim 17, wherein:
the leader refuse vehicle further comprises:
a chassis; and
a cab coupled to the chassis, the user device positioned within the cab; and
the follower refuse vehicle is a cabless refuse vehicle.

19. The leader-follower system of claim 17, wherein the user device is a portable user device configured to wirelessly connect to the telematics unit to provide the input data to the telematics unit.

20. The leader-follower system of claim 17, wherein:
the follower refuse vehicle further comprises:
a chassis; and
a body coupled to the chassis, the body defining a refuse compartment configured to store refuse therein;
the input data corresponds to a refuse container, and
the control signals cause the one or more controllable elements of the follower refuse vehicle to engage the refuse container and transfer refuse from the refuse container into the refuse compartment of the follower refuse vehicle.
